(19) United States
(12) Patent Application Publication
(10) Pub. No.: US 2021/0070143 A1
(43) Pub. Date: Mar. 11, 2021

(54) Ventilation Device

(71) Applicant: Truongson Ton, San Jose, CA (US)

(72) Inventor: Truongson Ton, San Jose, CA (US)

(21) Appl. No.: 16/561,992

(22) Filed: Sep. 5, 2019

(51) Int. Cl. B60H 1/00; B60H 1/24; B60H 1/26

(52) U.S. Cl. CPC B60H 1/00828; B60H 1/00564; B60H 1/26; B60H 1/245; B60H 1/244

(57) ABSTRACT

A ventilation device for cooling a passenger compartment of a vehicle includes a blower module that is operationally coupled to an electrical circuit of a vehicle. A first duct assembly and a second duct assembly are coupled to the vehicle. The first duct assembly extends between a passenger compartment and at least one of a trunk and an opening in an exterior surface of the vehicle. The second duct assembly extends between the passenger compartment and an aperture in the exterior surface of the vehicle. At least one of the first duct assembly and the second duct assembly are operationally coupled to the blower module. The blower module is configured to exchange air in the passenger compartment with air from an ambient environment in which the vehicle is positioned to cool the passenger compartment.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to ventilation devices and more particularly pertains to a new ventilation device for cooling a passenger compartment of a vehicle.

### (2) Description of Related Art Including Information Disclosed Under 37 CFR 1.97 and 1.98

The prior art relates to ventilation devices.

### BRIEF SUMMARY OF THE INVENTION

An embodiment of the disclosure meets the needs presented above by generally comprising a blower module that is operationally coupled to an electrical circuit of a vehicle. A first duct assembly and a second duct assembly are coupled to the vehicle. The first duct assembly extends between a passenger compartment and at least one of a trunk and an opening in an exterior surface of the vehicle. The second duct assembly extends between the passenger compartment and an aperture in the exterior surface of the vehicle. At least one of the first duct assembly and the second duct assembly are operationally coupled to the blower module. The blower module is configured to exchange air in the passenger compartment with air from an ambient environment in which the vehicle is positioned to cool the passenger compartment.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING

The disclosure will be better understood and objects other than those set forth above will become apparent when consideration is given to the following detailed description thereof. Such description makes reference to the annexed drawings wherein:

FIG. 1 is a side view of a ventilation device according to an embodiment of the disclosure.

FIG. 2 is a top view of an embodiment of the disclosure.

FIG. 3 is a bottom view of an embodiment of the disclosure.

FIG. 4 is a cross-sectional view of an embodiment of the disclosure.

FIG. 5 is a block diagram of an embodiment of the disclosure.

### DETAILED DESCRIPTION OF THE INVENTION

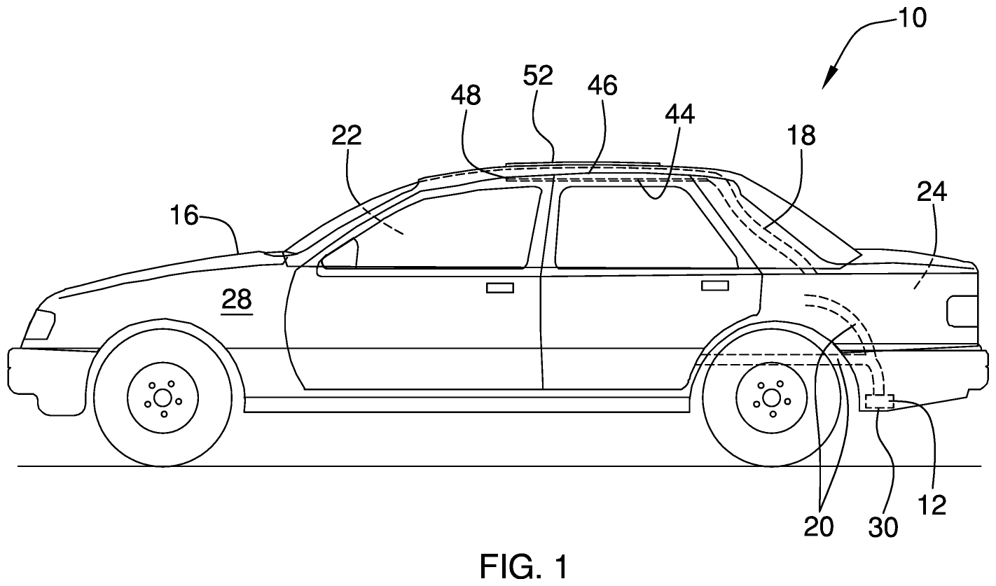

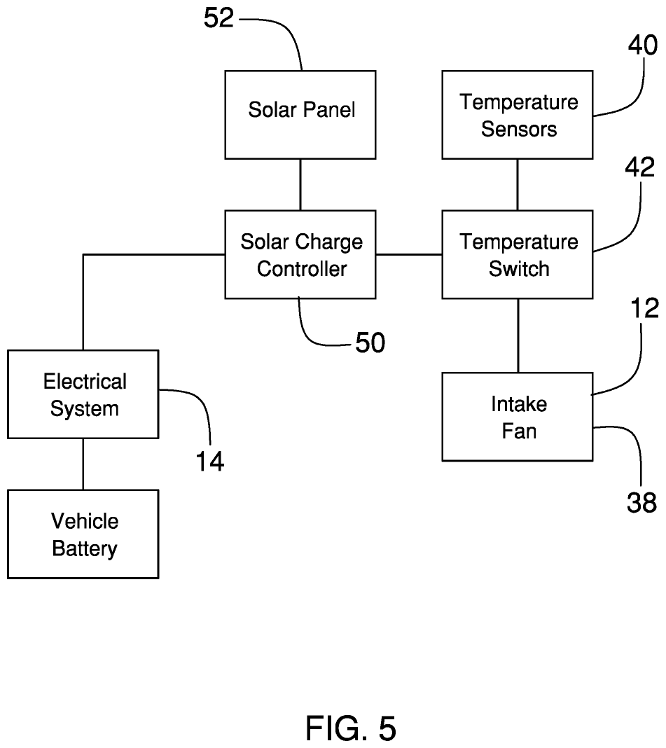

With reference now to the drawings, and in particular to FIGS. 1 through 5 thereof, a new ventilation device embodying the principles and concepts of an embodiment of the disclosure and generally designated by the reference numeral 10 will be described.

As best illustrated in FIGS. 1 through 5, the ventilation device 10 generally comprises a blower module 12 that is operationally coupled to an electrical circuit 14 of a vehicle 16. A first duct assembly 18 and a second duct assembly 20 are coupled to the vehicle 16. The first duct assembly 18 extends between a passenger compartment 22 and at least one of a trunk 24 and an opening 26 in an exterior surface 28 of the vehicle 16. The second duct assembly 20 extends between the passenger compartment 22 and an aperture 30 in the exterior surface 28 of the vehicle 16. At least one of the first duct assembly 18 and the second duct assembly 20 are operationally coupled to the blower module 12.

The blower module 12 is configured to exchange air in the passenger compartment 22 with air from an ambient environment in which the vehicle 16 is positioned to cool the passenger compartment 22. A vehicle 16 equipped with the device 10 is provided a number of benefits, including a measure of safety in event a person is left unattended in the vehicle 16, a cooler environment upon entry to the vehicle 16, and less energy being required to initially cool the vehicle 16.

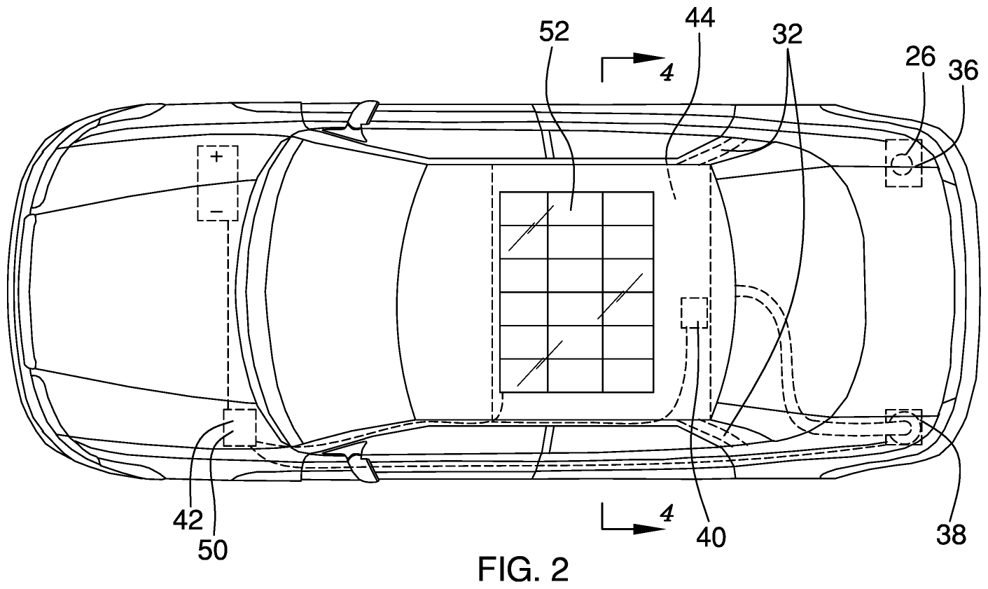

The first duct assembly 18 may comprise a pair of first ducts 32. Each first duct 32 extends from the opening 26 to proximate to a roof and a respective opposing side of the passenger compartment 22. The first ducts 32 are configured to draw hot air from proximate to the roof of the vehicle 16. The present invention also anticipates the first duct assembly 18 comprising other numbers of first ducts 32, such as one first duct 32, three first ducts 32, and four first ducts 32. The pair of first ducts 32 also may intersect such that only one of the pair of first ducts 32 extends to the opening 26. Additionally, the pair of first ducts 32 may terminate in the trunk of the vehicle 16, as shown in FIG. 2. In this configuration, the hot air would flow through the trunk to exit through the opening 26.

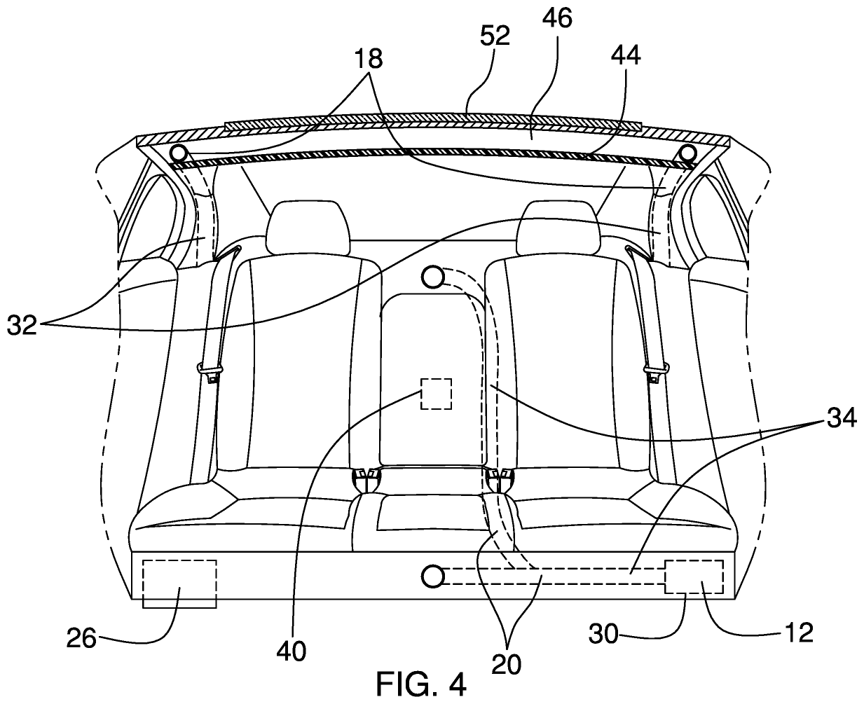

The second duct assembly 20 comprises a pair of second ducts 34. Each second duct 34 extends from the aperture 30 to the passenger compartment 22 so that the second ducts 34 terminate lower in the passenger compartment 22 relative to the first ducts 32. The second ducts 34 are configured to expel intake air into the passenger compartment 22 below the first ducts 32. The present invention also anticipates the second duct assembly 20 comprising other numbers of second ducts 34, such as one second duct 34, three second ducts 34, and four second ducts 34. The pair of second ducts 34 also may intersect, as shown in FIG. 4, such that only one of the pair of second ducts 34 extends to the aperture 30.

One of the second ducts 34 may extend through a rear seat of the vehicle 16, as shown in FIG. 4, substantially equally distant from the opposing sides of the passenger compartment 22 so that the second duct 34 expels cool air proximate to a head of a person who is positioned in the rear seat. The other of the second ducts 34 may terminate at a front edge of the rear seat substantially equally distant from the opposing sides of the passenger compartment 22 so that the second duct 34 expels cool air proximate to a floor of the passenger compartment 22. The present invention anticipates the second ducts 34 terminating at other positions within the passenger compartment 22, such as, but not limited to, proximate to a front edge of a respective front seat, proximate to the opposing sides of the passenger compartment 22, and from vents positioned in the passenger compartment 22.

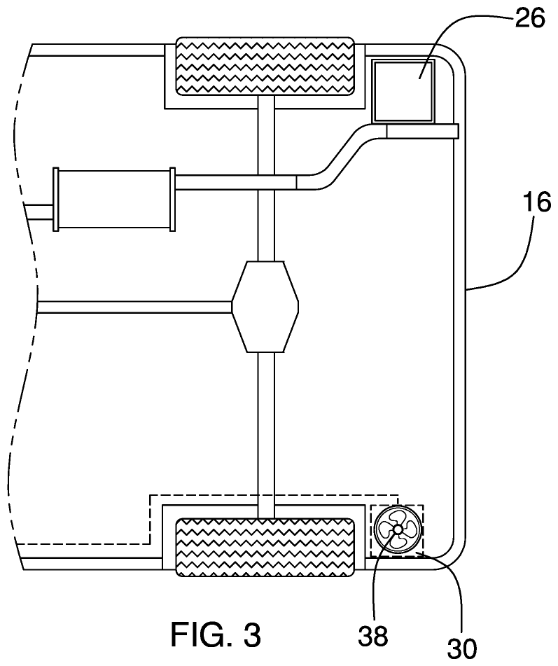

The blower module 12 comprises at least one of an exhaust fan 36 that is operationally coupled to the first duct assembly 18 and an intake fan 38 that is operationally coupled to the second duct assembly 20. The exhaust fan 36 is coupled to the vehicle 16 proximate to an opening 26 that is positioned in a lower panel of the trunk 24 proximate to a respective corner of the vehicle 16, as shown in FIG. 3. The intake fan 38 is coupled to the vehicle 16 proximate to an aperture 30 that is positioned in the lower panel of the trunk 24 proximate to a respective corner of the vehicle 16, as shown in Figure.

A temperature sensor 40 that is coupled to the vehicle 16 within the passenger compartment 22 is configured to measure a temperature of the air in the passenger compartment 22. A switch 42 is operationally coupled to the temperature sensor 40 and the blower module 12 so that the switch 42 is positioned to selectively actuate the blower module 12 in event the temperature of the air in the passenger compartment 22 exceeds a predetermined temperature, for example, 70, 80, 90, 100, and 105 degrees Fahrenheit.

A panel 44 is coupled to and extends between the opposing sides of the passenger compartment 22, proximate to the roof as shown in FIG. 4, to define a chamber 46. The first duct assembly 18 extends between the chamber 46 and the opening 26. A front 48 of the chamber 46 is open so that the chamber 46 is configured for entry of hot air from the passenger compartment 22. The first duct assembly 18 is positioned to direct the hot air from the chamber 46 through the opening 26.

A controller 50 is operationally coupled to a battery of the vehicle 16, the temperature sensor 40, the switch 42, and the blower module 12. The controller 50 is configured to selectively couple the temperature sensor 40, the switch 42, and the blower module 12 to the battery.

A solar panel 52 is coupled to the exterior surface 28 of the vehicle 16. The solar panel 52 may be positioned on the roof of the vehicle 16, as shown in FIG. 1, but also could be positioned in other locations on the vehicle 16, such as the trunk 24. The solar panel 52 is operationally coupled to the controller 50 so that the controller 50 is positioned to selectively power the temperature sensor 40, the switch 42, and the blower module 12 with direct current from the solar panel 52. The controller 50 is configured to selectively supply direct current from the solar panel 52 to the battery to charge the battery.

In use, the temperature sensor 40 is positioned to signal the switch 42 to actuate the blower module 12 in the event the temperature of the air in the passenger compartment 22 exceeds the predetermined temperature. The blower module 12 draws cool air from the ambient environment through the aperture 30 and the second duct assembly 20 into the passenger compartment 22 concurrently with warm or hot air being expelled from the chamber 46 through the first duct assembly 18 and the opening 26.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the elements is present, unless the context clearly requires that there be only one of the elements.

I claim:

1. A ventilation device comprising:
a blower module operationally coupled to an electrical circuit of a vehicle; and
a first duct assembly and a second duct assembly coupled to the vehicle, the first duct assembly extending between a passenger compartment and at least one of a trunk and an opening in an exterior surface of the vehicle, the second duct assembly extending between the passenger compartment and an aperture in the exterior surface of the vehicle, at least one of the first duct assembly and the second duct assembly being operationally coupled to the blower module wherein the blower module is configured for exchanging air in the passenger compartment with air from an ambient environment in which the vehicle is positioned for cooling the passenger compartment.

2. The device of claim 1, further comprising:
the first duct assembly comprising a pair of first ducts, each first duct extending from the opening to proximate to a roof and a respective opposing side of the passenger compartment wherein the first ducts are configured for drawing hot air from proximate to the roof; and
the second duct assembly comprising a pair of second ducts, each second duct extending from the aperture to the passenger compartment such that the second ducts terminate lower in the passenger compartment relative to the first ducts wherein the second ducts are configured for expelling intake air into the passenger compartment below the first ducts.

3. The device of claim 2, further including one of the second ducts extending through a rear seat of the vehicle substantially equally distant from the opposing sides of the passenger compartment such that the second duct expels cool air proximate to a head of a person positioned in the rear seat, the other of the second ducts terminating at a front edge of the rear seat substantially equally distant from the opposing sides of the passenger compartment such that the second duct expels cool air proximate to a floor of the passenger compartment.

4. The device of claim 1, further including the blower module comprising at least one of an exhaust fan operationally coupled to the first duct assembly and an intake fan operationally coupled to the second duct assembly.

5. The device of claim 4, further including the exhaust fan being coupled to the vehicle proximate to an opening positioned in a lower panel of the trunk proximate to a respective corner of the vehicle.

6. The device of claim 4, further including the intake fan being coupled to the vehicle proximate to an aperture positioned in a lower panel of the trunk proximate to a respective corner of the vehicle.

7. The device of claim 1, further comprising:
a temperature sensor coupled to the vehicle within the passenger compartment wherein the temperature sensor is configured for measuring a temperature of the air in the passenger compartment; and
a switch operationally coupled to the temperature sensor and the blower module such that the switch is positioned for selectively actuating the blower module in event the temperature of the air in the passenger compartment exceeds a predetermined temperature.

8. The device of claim 1, further including a panel coupled to and extending between opposing sides of the passenger compartment proximate to a roof of the vehicle defining a chamber, the first duct assembly extending between the chamber and the opening, a front of the chamber being open wherein the chamber is configured for entering of hot air from the passenger compartment positioning the first duct assembly for directing the hot air through the opening.

9. The device of claim 7, further comprising:
a controller operationally coupled to a battery of the vehicle, the temperature sensor, the switch, and the blower module wherein the controller is configured for selectively coupling the temperature sensor, the switch, and the blower module to the battery; and
a solar panel coupled to the exterior surface of the vehicle, the solar panel being operationally coupled to the controller such that the controller is positioned for selectively powering the temperature sensor, the switch, and the blower module with direct current from the solar panel and wherein the controller is configured for selectively supplying direct current from the solar panel to the battery for charging the battery.

10. A vehicle and ventilation device combination comprising:
a vehicle;
a blower module operationally coupled to an electrical circuit of the vehicle; and
a first duct assembly and a second duct assembly coupled to the vehicle, the first duct assembly extending between a passenger compartment and at least one of a trunk and an opening in an exterior surface of the vehicle, the second duct assembly extending between the passenger compartment and an aperture in the exterior surface of the vehicle, at least one of the first duct assembly and the second duct assembly being operationally coupled to the blower module wherein the blower module is configured for exchanging air in the passenger compartment with air from an ambient environment in which the vehicle is positioned for cooling the passenger compartment.

11. A ventilation device comprising:
a blower module operationally coupled to an electrical circuit of a vehicle;
a first duct assembly and a second duct assembly coupled to the vehicle, the first duct assembly extending between a passenger compartment and at least one of a trunk and an opening in an exterior surface of the vehicle, the second duct assembly extending between the passenger compartment and an aperture in the exterior surface of the vehicle, at least one of the first duct assembly and the second duct assembly being operationally coupled to the blower module wherein the blower module is configured for exchanging air in the passenger compartment with air from an ambient environment in which the vehicle is positioned for cooling the passenger compartment, the first duct assembly comprising a pair of first ducts, each first duct extending from the opening to proximate to a roof and a respective opposing side of the passenger compartment wherein the first ducts are configured for drawing hot air from proximate to the roof of the vehicle, the second duct assembly comprising a pair of second ducts, each second duct extending from the aperture to the passenger compartment such that the second ducts terminate lower in the passenger compartment relative to the first ducts wherein the second ducts are configured for expelling intake air into the passenger compartment below the first ducts, one of the second ducts extending through a rear seat of the vehicle substantially equally distant from the opposing sides of the passenger compartment such that the second duct expels cool air proximate to a head of a person positioned in the rear seat, the other of the second ducts terminating at a front edge of the rear seat substantially equally distant from the opposing sides of the passenger compartment such that the second duct expels cool air proximate to a floor of the passenger compartment, the blower module comprising at least one of an exhaust fan operationally coupled to the first duct assembly and an intake fan operationally coupled to the second duct assembly, the exhaust fan being coupled to the vehicle proximate to an opening positioned in a lower panel of the trunk proximate to a respective corner of the vehicle, the intake fan being coupled to the vehicle proximate to an aperture positioned in the lower panel of the trunk proximate to a respective corner of the vehicle;
a temperature sensor coupled to the vehicle within the passenger compartment wherein the temperature sensor is configured for measuring a temperature of the air in the passenger compartment;
a switch operationally coupled to the temperature sensor and the blower module such that the switch is positioned for selectively actuating the blower module in event the temperature of the air in the passenger compartment exceeds a predetermined temperature;
a panel coupled to and extending between the opposing sides of the passenger compartment proximate to the roof defining a chamber, the first duct assembly extending between the chamber and the opening, a front of the chamber being open wherein the chamber is configured for entering of hot air from the passenger compartment positioning the first duct assembly for directing the hot air through the opening;
a controller operationally coupled to a battery of the vehicle, the temperature sensor, the switch, and the blower module wherein the controller is configured for selectively coupling the temperature sensor, the switch, and the blower module to the battery; and
a solar panel coupled to the exterior surface of the vehicle, the solar panel being operationally coupled to the controller such that the controller is positioned for selectively powering the temperature sensor, the switch, and the blower module with direct current from the solar panel and wherein the controller is configured for selectively supplying direct current from the solar panel to the battery for charging the battery.
